(19) United States
(12) Patent Application Publication
(10) Pub. No.: US 2017/0018211 A1
(43) Pub. Date: Jan. 19, 2017

(54) Material Sampler

(71) Applicant: Mykola Adeyev, London (GB)

(72) Inventors: Mykola Adeyev, London (GB); James Watson, Cambridge (GB); Robert Curtis, Cambridgeshire (GB); Ben Crundwell, Hertforshire (GB); Andrew Julian Stockdale, Cambridge (GB)

(21) Appl. No.: 15/125,008

(22) PCT Filed: Mar. 10, 2015
(86) PCT No.: PCT/GB2015/050698

§ 371 Date: Sep. 9, 2016

(30) Foreign Application Priority Data
Mar. 10, 2014 (GB) 1404143.8

(51) Int. Cl. G09F 5/00; G09F 11/30; G09F 11/21; G09F 11/22

(52) U.S. Cl. CPC G09F 5/00; G09F 11/22; G09F 11/30; G09F 11/21; G09F 2005/048

(57) ABSTRACT

An apparatus (1) arranged to store and display a plurality of material samples (9), the apparatus (1) comprising a plurality of sample supports (21) arranged to hold the material samples (9), the sample supports (21) being moveable to allow a user to access a selected material sample (9); a controller (27) configured to receive a selection identifying a material sample (9) to be displayed; and a display mechanism configured to move the selected sample (9) from a first position, in which the selected sample (9) is not visible, to an extended position in which the selected sample (9) is visible and/or touchable by a user.

This invention relates to a system for storing and/or providing material samples. In particular, but not exclusively, this invention relates to an apparatus for storing and providing material samples for on-line shopping, often referred to as Internet shopping.

Where collections of materials are kept, which can often be large, the samples are often kept in sample books. However such hooks sic bulky and especially where a large number of samples are stored, it is time, consuming to find the correct sample. Other times, samples of material may be kept in a more chaotic manner.

Furthermore, the advent of the World Wide Web has led to a significant increase in home shopping via websites provided by retailers. When shopping for items such as clothing, clothing accessories or home furnishing, the texture, weight and feel of the material that the item is made from can be important However, home on-line shopping can only provide information about the appearance of a material.

According to a first aspect of the invention, there is provided an apparatus arranged to store and display a plurality of material samples. The apparatus may comprise a plurality of sample supports arranged to hold the material samples, the sample supports being moveable to allow a user to access a selected material sample. The apparatus may further comprise a controller configured to receive a selection identifying a material sample to be displayed. The apparatus may also comprise a display mechanism configured to move the selected sample from a first position, in which the selected sample is not visible, to an extended position in which the selected sample is visible and touchable by a user. In addition, the apparatus may comprise a retention mechanism configured to prevent removal of the selected sample from the apparatus.

According to a second aspect of the invention, there is provided an apparatus for storing a plurality of material samples. The apparatus may comprise a plurality of sample holders. The sample holders may be arranged to hold a material sample and may be moveable to allow a user to access the material sample held thereby. The apparatus may further comprise a controller configured to receive a selection identifying a material sample to be displayed. The apparatus may also comprise a mechanism configured to in response to the selection identifying the material sample to be displayed, move the sample holder holding the selected material sample from a retracted position in which a material sample held in the holder is not visible, to an extended position in which a sample held in the holder is visible.

Embodiments of the invention providing such a system are advantageous because they provide material samples to a home Internet shopper in an easy to access, portable and space saving way.

Embodiments of the invention providing such a system are also advantageous in scenarios where large collections of material samples are kept, sine they provide an easy to access, space saving way of storing material samples.

Certain aspects anchor embodiments of the invention may be provided on a machine readable medium. In such aspects and/or embodiments, the machine readable medium may comprise any one or more of the following: a CD ROM; a DVD ROM or RAM (including −R/−RW and +R/+RW); a memory (such as an SD card, a Compact Flash card; a USB memory drive; a Flash drive), any form of magneto optical storage, a floppy disc; a transmitted signal (such as an Internet download, an FTP transfer, or the like); a wire,

The invention will now be further described by way of example only with respect to the following drawings in which:

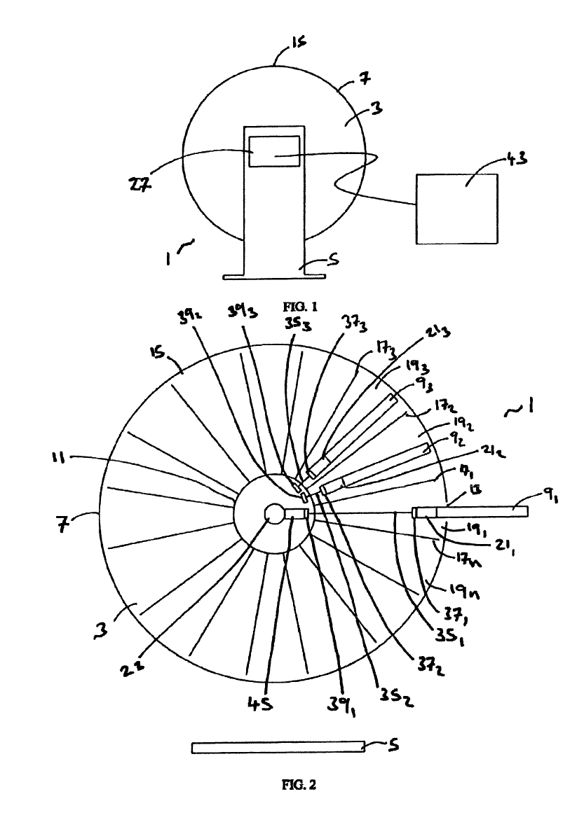

FIG. 1 is a side view of an apparatus for storing and providing material samples;

FIG. 2 is cut-through of the apparatus shown in FIG. 1;

FIG. 3 is a front view of the apparatus shown in FIG. 1;

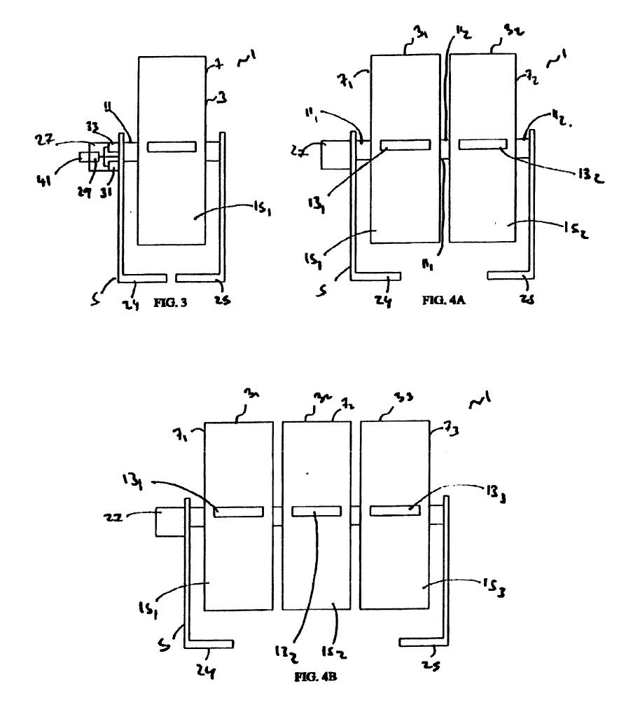

FIGS. 4A, and B show a front view of an apparatus according to FIG. 1 with a plurality of sets of samples;

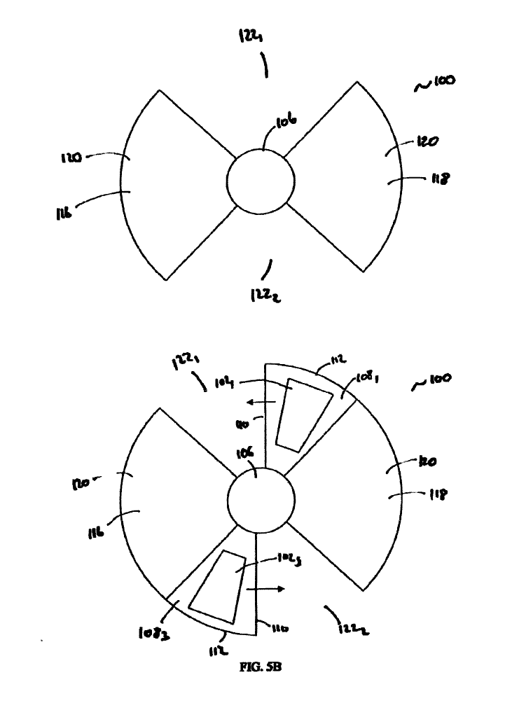

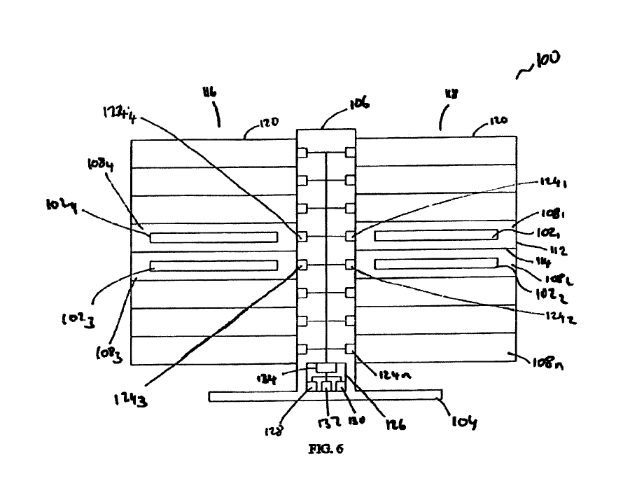

FIGS. 5A and 5B are top views of an alternative apparatus for providing and storing material samples;

FIG. 6 is a cut-through view of the apparatus shown in FIGS. 5A and 5B.

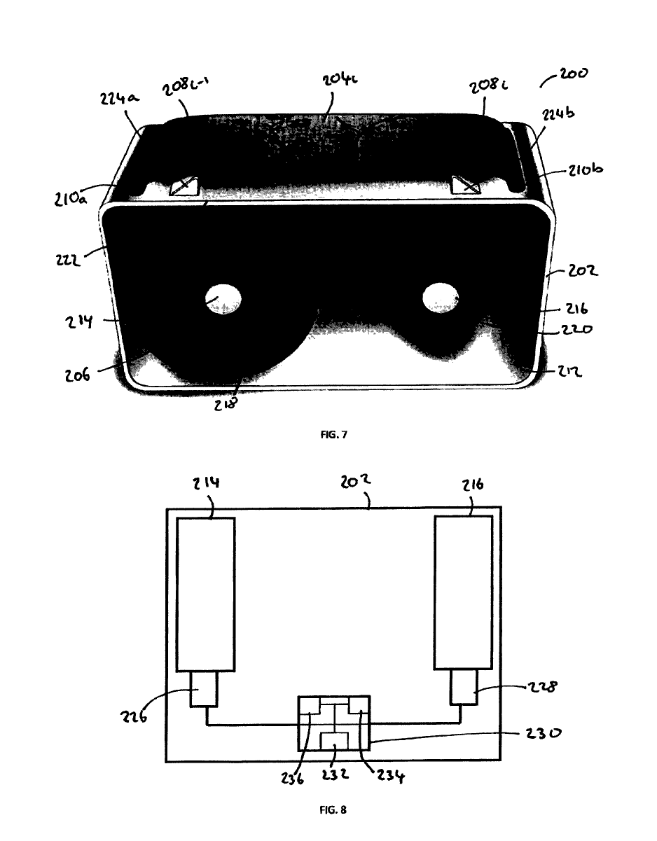

FIG. 7 shows a perspective view of a further alternative apparatus for providing and storing material samples;

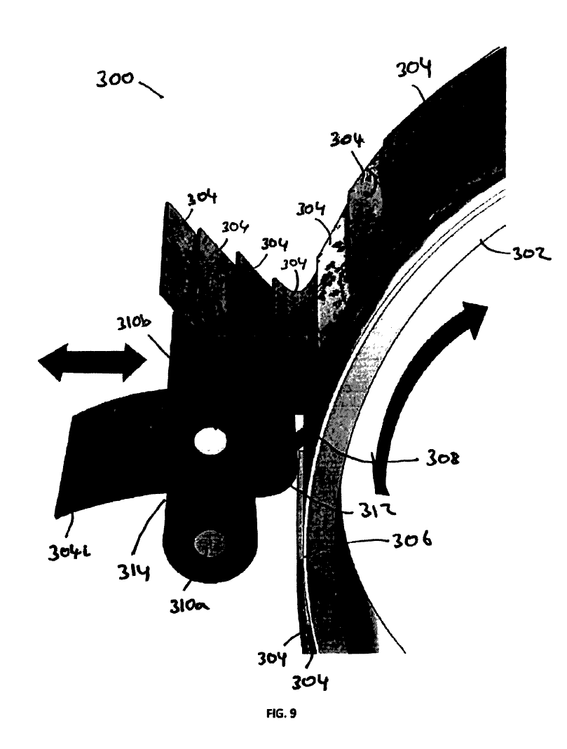

FIG. 8 shows a schematic plan view of the operating mechanism of the apparatus of FIG. 7; and

FIG. 9 shows a further alternative apparatus.

FIGS. 1, 2 and 3 show an apparatus 1 comprising a sample container 3, a base 5 and a controller 27.

Sample container 3 is formed from a cylindrical housing 7 with an aperture 13 provided in the side-wall 15 of the housing 7. A shaft 11 passes through the housing 7, along the central axis of the sample container 3, The shaft 11 and housing 7 are arranged so that the shaft 11 is able to rotate relative to housing 7; the housing 7 is able to rotate around the shaft 11 with the base 5 being in a fixed orientation relative to the housing 7.

Within the housing 7, a number of dividing walls 17₁ . . . 17ₙ project from a region of the shaft 11 to define compartments 19₁ . . . 19ₙ between neighbouring dividing walls 17. For reasons of clarity, the number of dividing walls 17 and compartments 19 has been reduced within the Figure than may actually be provided within an embodiment.

The dividing walls 17 extend along the extent of the shaft 11 that is within the housing 7 with the dividing walls having a fixed orientation relative to the shaft 11. Also, when viewed in cross section (FIG. 2), the dividing walls 17 extend radially from the shaft 11 towards the cylindrical side-wall 15. Clearance gaps may be provided where the dividing walls 17 approach the housing 7 to allow free movement of the shaft 11 relative to the housing 7. As noted below, in use, the housing 7 remains stationary whilst the dividing walls 17 and shaft 11 rotate therewithin.

Each compartment 19 is provided with a sample holder 21₁ . . . 21ₙ arranged to hold a sample of material 9. In the embodiment being described, each sample holder 21 is mounted at one side thereof on a rail (not shown) along which the sample holder can, in use, slide and at the other side thereof on a worm gear 35 which is used to move the sample holder 21.

Other embodiments may provide more than one worm gear 35, and may for instance provide a worm gear at each side of the sample holder 21.

Thus, the worm gear 35 provides a mechanism to cause the sample holder 21 to move between a retracted position and an extended position. The sample holder 21₂ in FIG. 2 exemplifies the retracted position with both the sample holder 21₂, and associated sample 9₂ being contained between the dividing walls 17 and within the housing 7. The sample holder 21₁ in FIG. 2 exemplifies the extended position in which at least a portion of the sample 9₁, held by the sample holder 21, extends beyond the housing 7.

Aperture 13 is sized to allow a single sample of material 9₁ . . . 9ₙ to pass through it. When a sample holder 21 is in an extended position, aligned with aperture 13. the sample projects through the aperture 13. A portion of the sample holder 21 may project through the aperture to allow for easy replacement of samples. Typically, the aperture 13 has a height that extends for substantially the length of the chord between neighbouring dividing walls 17 thereby facilitating extension of the sample 9 therethrough. However, for ease of understanding the Figures show the aperture having a smaller opening than this in view of the reduced number of compartments 19.

To prevent unwanted movement of sample holders 21 when in the retracted position, the sample bolder 21 is secured to the shaft 11 or dividing walls 17 at a base region of the sample holder 21, The sample holder 21 may be secured by a snap fit projection, or other temporary retaining means, provided between formations formed in the sample holder 21 and/or the surface of the shaft 11 or the dividing walls 17.

Each sample holder 21 is arranged to receive a material sample 9₁ . . . 9ₙ. In the example shown, the sample holder 21 may include a clamp to hold the end of material sample 9. In other embodiments, the sample holder may be a case that the material sample 9 is held in.

In the embodiment being described, the shaft 11 is hollow, with a fixed bar 23 running down a centre region of the shaft 11. The fixed bar 23 is arranged such that it does not rotate with respect to the shaft 11 thereby having a fixed orientation with the housing 7 and base 5. A driven gear 37 arranged to co-operate with the worm gear 35 is mounted on each sample holder 21 and thereby rotation of the worm gear 35 causes movement of the sample holder 21 relative to the worm gear 35. An end region of the worm gear 35 extends into the shaft 11 and has a drive gear 39 on an end thereof.

A sample motor 45 is provided within the shaft 11 and arranged to engage with the drive gear 39 provided on the end of the worm gear 35 of the compartment 19 aligned with the aperture 13 (ie compartment 19₁ of FIG. 2), Thereby, the sample motor 45 can rotate the worm gear 35 thereby causing the sample holder 21 to move between the extended and retracted positions.

Base 5 is formed of first base portion 24 and second base portion 25. The sample container 3 is supported by shaft 11 between the first 24 and second portions 25. The base 5 holds the housing 7 and fixed bar 23 in position so that they do not move when shaft 11 is rotated. This can be achieved by any suitable engagement between the first 24 and/or second 25 base portions and the ends of the housing 7.

Controller 27 includes at least a processing circuitry 29, which may be a processor, micro controller, or the like. The processing circuitry has access to or may include a memory 31. Further, the controller 27 includes a shaft motor 33 arranged to rotate the shaft 11. In the embodiment being described, the shaft motor 33 is a stepper motor and such embodiments are believed convenient as a means for accurately positioning the sample container 3.

The memory 31 stores information identifying material stored in each compartment 19, an angular position associated with each compartment 19 and a current compartment aligned with aperture 13. The shaft motor 33 engages shaft 11 via a set of gears.

In use controller 27 receives an input identifying a sample 9 to be viewed. Controller accesses memory 31 to identify the compartment 19 associated with the sample 9, the angular position of the identified compartment 19 and the angular position of the current compartment aligned with aperture 13. The controller determines the angular difference between the identified compartment 19 and the compartment 19 currently aligned with the aperture 13 and controls the shaft motor 33 to move the shaft 11 the determined angular difference. This aligns the identified compartment 19 with the aperture 13, and the sample motor 45 with the drive gear 39 provided on the end of the worm gear 35 of the identified compartment 19.

Controller 27 then controls the sample motor 45 to rotate the worm gear 35 thereby moving the sample holder 21 in the identified compartment 19 to the extended position.

On receipt of an input identifying a different compartment 19 or an input indicating that the current sample 9 is no longer required, the controller 27 again actuates the sample motor 45 to rotate the worm gear 35 thereby moving the sample holder 21 to the retracted position.

Controller 27 may comprise an interface 41 to receive an input identifying a sample 9 to be viewed. In one example, the interface 41 may be a communications interface for receiving a signal identifying a sample 9 horn a remote computer device 43. Examples of suitable interfaces include a Universal Serial Bus (USB) or a short range wireless interface such a wireless local area network (WLAN) or BlueTooth.

The remote computing device 43 may be any Internet connected device suitable for Internet shopping. For example, the remote computing device may be a Personal Computer (PC), laptop, PDA, tablet (such an iPad; Kindle; Android device); smart phone or the like.

In some embodiments, the sample container 3 as described above may be provided by a retailer. As such samples of material within the container may be used to show the materials used in a catalogue or website, the website or catalogue listing the items the retailer has available. Where the container 3 holds samples 9 of material relating to an item listed, an option to touch or test the material might provided on a website. A user browsing the retailer's website or catalogue can then select the touch/test option and the computing device 43 sends a signal, via interface 41, to controller 27, the signal identifying the material.

It will further be appreciated that the function of the controller 27 may be distributed over several entities, For example, the remote computing device 43 or website may hold the information relating to which sample 9 is in which compartment and simply identify a holder number, or angular position to the controller 27.

It will further be appreciated that although the figures show the controller 27 as part of the base 5, it may be comprised in the sample container 3. For example, the controller 27 may be received in the hollow shaft 11.

Furthermore, sample container 3 may be removable and replaceable. In examples where the controller 27 is part of the base 5, an update to the memory 31 may be required. However, where the controller 27 is part of the sample container 3, a new controller 27 may be provided with a new sample container 3.

FIGS. 4A and 4B show further embodiments in which the apparatus comprises two or three sample containers. In these embodiments, individual controllers 27₁, 27₂, 27₃ may be associated with each container 3₁, 3₂, 3₃. Furthermore, a further controller 3 may be provided to co-ordinate inputs to the separate containers 3, however, this is not necessary.

Where multiple sample containers are provided, the shafts 11₁, 11₂, 11₃ may couple to form a single extended shaft 11. Alternatively, the fixed bars 23₁, 23₂, 23₃ may couple together so that shafts 11₁, 11₂ and 11₃ can rotate independently of one another.

The apparatus 1 may be configurable to have any timber of sample containers 3 such that a user can add and remove containers 3 as desired.

It will be appreciated that the controller 27 may comprise a user interface (not shown). The interface may comprise a display and a input device such as a touch screen or a keyboard of any layout. The user can browse and select available materials via the interface. As such the apparatus 1 stands alone, without the remote computing device 43. This may be particularly useful where the apparatus 1 is used to better store and sort large collection of materials samples 9. Such embodiments may therefore be advantageous to store and provide easy access to sample libraries.

Although the base 5 has been shown as having two parts 24, 25, it will be appreciated that the base may be formed unitarily or from more than two parts. Furthermore, the base need not be provided on both ends or the housing 7.

It will be appreciated that although the above examples have been described with dividing walls 17 forming compartments 19 separating sample holders 21, the dividing walls are not necessary and may be omitted. It may be that the shaft and worm gear 35 associated with each sample holder 21 provide sufficient location of the sample holders 21. Embodiments having dividing walls 17 might be convenient to provide isolation of the material samples.

It will also be appreciated that although the above example has been described as including a rail (not shown), the rail may be omitted and any suitable arrangement used to guide the sample holder 21 between the retracted and extended positions. For example, the sample holder 21 may engage with guides provided on the dividing walls 17 of the compartments 19.

In addition, it will be appreciated that although it has been described that the shaft 11 rotates relative to the fixed bar 23 and housing 7 to align aperture 13, the opposite may be true, where the shaft 11 is fixed and housing 7 and fixed bar 23 rotate to align the aperture 13 and driver 37 with the desired sample 9.

The memory 31 may be any suitable form of memory. In one example, the memory 31 may be a removable memory (such a removable memory may be provided by an SD card; Compact Flash card; USB memory stick; or the like) such that it can be easily replaced if the container 3 is replaced.

Although the sample container 3 has been illustrated with sixteen compartments 19, it will be appreciated that there may be any suitable number of compartments 19.

FIGS. 5A, 5B and 6 show an alternative apparatus 100 for storing and providing material samples 102. Unless stated otherwise, any of the features or variations discussed above my also be applied to the alternative apparatus 100.

The apparatus 100 comprises a base 104, shaft 106 and a plurality of sample holders 108₁ . . . 108ₙ.

Sample holders 108 are arranged around shaft 106 and are shaped as a ninety degree sector of a circle, cut off towards the centre were the sample holder 108 meets the shaft 106. The sample holders 108 are in the form of open containers having side walls 110, circumferential end walls 112 and a base 114.

As with the previously discussed apparatus 1, sample holders 108 are moveable between a retracted position (as shown in FIG. 5A) and an extended position (as shown in FIG. 5B).

When all sample holders 108 are in the retracted position, the apparatus is provided with a first set of sample holders 116 and a second sat of sample holders 118. The sample holders 108 in each set 116, 118 are signed to overlay one another and form separate stacks. An additional cover 120 may be arranged on the top of each set of multiple holders 116, 118 to cover the top most sample container 108 when in the retracted position.

The fast set 116 is arranged on the opposite side of the shaft 106 to the second set 118. The sample holders 108 are ninety degree sectors, therefore the apparatus is provided with spaces 122₁ and 122₂ around the shaft 106, between the sample holders 108.

Sample holders 108 are able to rotate around shaft 106 to move between the retracted and extracted positions. To move from the retracted position to the extracted, a sample holder, for example 108₃ in the first set of sample holders 116 rotates around shaft 106 into space 122₂. Similarly, a sample holder, for example 108₁, from the second set of sample holders 118 rotates around shaft 106 into space 122₃.

Sample holders 108 are provided on mounts 124₁ . . . 124ₙ. The mounts 124 are received in shaft 106 and, when activated, move the sample holder between the extracted and retracted positions. Mounts 124 are activated by a controller 126, which is received in the base of the shaft 106.

Controller 126 receives an input, identifying a sample 102 to be viewed, over interface 128. Processor 132, receives the signal and identifies the corresponding holder 108 from lookup information stored in memory 130. Mount interface 134 then activates the mount 124 corresponding to the identified sample holder 108.

In the example shown, each mount 124 includes a motor (riot shown) to control movement of the mount 124. Mount interface 134 addresses the identified mount through use of switching. However, it will be appreciated that in an alternative example, a single motor moves within shaft 106 and is able to engage with the respective mounts 124 to move the sample holders 108.

The input received by the controller 126 of apparatus 100 can be provided in the Same way as the input received by the controller 27 in the previously discussed apparatus 1.

It will be appreciated that although FIGS. 5 and 6 show sample holders 108 as ninety degree segments, smaller or larger segments may be used Similarly, although the examples show two sets 116, 118 of sample holders 108, there may be a single set or there may be more than two sets.

In the examples of apparatus 100 shown, the sets of sample holders 116, 118 are arrange on opposite sides of the shaft 106, with the sample holders moving in an anti-clockwise direction around the shaft 106. The sample holders may move clockwise or anti clockwise and the sets 116, 118 may be arranged in any suitable manner. For example, the sets 116, 118 may be adjacent, in which case, the sample holders 108 of the different sets 116, 118 move in opposite directions around the shaft 106.

In the examples of apparatus 100 shown, the sample holders 108 are open topped containers in which the sample 102 can be stored and taken out if a user wants to touch it. It will be appreciated that any suitable sample holder may be used. For example, the sample holder 108 could consist of a clamp to hold the sample 102 with or without the open topped container.

It will further be appreciated that although the mounts are shown being received in the shaft 106, they may be provided on the surface of the shaft 106 instead.

FIGS. 7 and 8 show a further alternative apparatus 200. FIG. 7 shows a perspective view of the apparatus 200, while FIG. 8 shows a schematic view of the internal components of the apparatus 200, in plan view.

In the current embodiment, the samples 204 are joined together end to end to form a single continuous tape 206. The samples 208 are separated by sample spacers 208 to distinguish the samples 204 from one another. The sample spacers 208 are of the came width as the samples 204, but may be of any suitable length.

The apparatus 200 comprises a housing 202, defining an internal volume 212, Within the volume 212, there are two cylindrical rollers 214, 216, around which the continuous tape 206 is wound.

A first end 218 of the tape 206 is connected (either fixedly or removably) to a first roller 214. The tape 206 is then wound around the first roller 214, and itself, before passing out of the volume 212 through a first aperture 210a.

The tape 206, then passes across an outer face 222 of the housing 202, and back into the volume 212 through a second aperture 210b. The tape 206 is held spaced from the housing outer surface 222 by tape spacers 224. The tape spacers 224 also servo to tension the part of the tape 206 passing outside the housing 202.

The tape 206 is then wound around the second roller 216 and the second end of the tape 220 is attached to the second roller 216.

The rollers 214, 216, can be rotated about an axis along their length. Since the tape 206 is attached to a roller 214, 216 at each end 218, 220 rotating both the rollers 214, 216 in a first direction causes the tape 206 to unwind from the first roller 214 and to wind around the second roller 220. Similarly, rotating both the rollers 214, 216 in the opposite direction causes the tape 206 to wind round the first roller 214 and unwind from the second roller 220. In this way, the portion of the tape 206 that passes outside of the housing 202 can be changed, and thus the sample 204 that can be seen and touched by a user can be changed.

As shown in FIG. 8, the cylindrical rollers 214, 216 are coupled to motors 226, 228, which are controlled by a controller 230. The controller 230 includes an interface 232, a memory 234, and a processor 236.

The memory 234 is configured to hold information identifying the respective position on the tape 20 of each sample 204. In a similar manner as described above, a selection of a sample is received via the interface 232. The selection is passed to the processor 236, which, using information stored in the memory 234, identifies the position of the selected sample 204, and powers the motors 226, 228 to wind the tape 206 such that the selected sample is outside of the housing 202.

This can be achieved in any number of suitable ways. For example, the memory 234 may also store the current position of the tape 206, and thus the processor is able to determine a distance and direction to move the tape 206. Alternatively, the processor may be determine the distance of the selected sample 204 from an end of the tape 206, mid be arranged to completely wind the tape 206 around the roller 214, 216 corresponding to the know end and then to control the motors 226, 228 to unwind the tape 206 the known amount.

In one example, the first motor 226, coupled to the first roller 214, may be activated to wind the tape 206 around the first roller 214, with the second motor 228, coupled to the second roller 216, off. Similarly, the second motor 228, may be activated to wind the tape 206 round the second roller 216, with the first motor 226 off. In this example, each motor 226, 228 only needs to work in one direction.

In other examples, both motors 226, 228 may be activated at the same time and may work in either direction.

It will also be appreciated that in some examples, the tape can be manually wound in addition to, or instead of, using the motors 226, 228. The apparatus 200 may also only comprise a single motor responsible for winding in both directions.

Since the tape 206 is attached to the rollers 214, 216, there will be a portion of the tape 206 at each end, 218, 220 that is never outside of the housing 202. This section may be formed of an extended spacer 208, or other material.

In FIGS. 7 and 8, the motor mechanism is integral with the housing 202 and tape 206. However, it will be appreciated that this is not necessarily the case. The tape 206 my be provided in a removable cartridge or cassette that is separate to and mountable on, the motors 226, 228. In this way, a single base unit having the motors 226, 228 can be used with multiple sets of samples 204.

11 will also be appreciated that where an integrated unit is provided, the housing 202 may have an opening (not sham) through which the tape 206 can be changed. This could be accomplished by removing the tape 206 from the rollers 214, 216 or removing the rollers 214, 216 and tape 206 as a single unit.

In the example shown, the samples 204 are elongate rectangles. The samples 204 and spacers 208 are sized so that only a single sample 204i is provided in a position outside the housing.

However, it will be appreciated that any shape and size of sample 204 may be used, provided it can fit through the apertures 210 and a sufficient number of samples can be fitted on to the tape 206. It will also be appreciated that the sample spacers 208 are optional and may be omitted altogether, and the samples 204 may be attached directly to each other. It may also be that the size and shape of the samples 304 (and spacers 308) can be configured such that more than one sample 204 can be provided outside the housing 202 at any one time.

It will also be appreciated that the tape spacers 224 are optional and may be omitted. Alternatively, only a single tape spacer 224, or more than to tape spacers 224 may be Used.

In other examples, there may be a movable tensioner (not shown) provided instead of or as well as the tape spacers 224 The tensioner may be received in the housing 202, between the rollers 214, 216. The tensioner can slide in an out of an aperture provided in the surface 222 of the housing 202, underneath the tape 206, In this way, when the tensioner is activated to move out of the housing, it will provide tension to the tape 206. The tensioner ma be actuated by a servo, controlled by the processor 236.

FIG. 9 shows a further alternative apparatus 300. The apparatus 300 of FIG. 9 comprises a wheel 302. The samples 304 are fixedly attached to the outer surface 306 of the wheel 302 by sample anchors 308 and are held such that they overlie each other around the outer surface of the wheel 302.

The apparatus also comprises a pair of rollers 310, adjacent the wheel 302, The rollers 310 are set up to rotate in the opposite direction to one another.

Initially, there is no sample 304 passing between the rollers 310. When the rollers 310 are activated so that the first roller 310a rotates in a first direction, and the second roller 310b rotates in the second direction, opposite the first, a sample 304i aligned with the gap 314 between the rollers 10 is drawn through gap 314 and held out The rollers 310 can then be stopped.

In this position, as shown in FIG. 9, a sample is held cut from the wheel 302, such that it can be clearly seen and touched by a user.

If the rollers 310 are then activated so that the first roller 310a rotates in the second direction, and the second roller 310b rotates in the first direction, the sample 304i is withdrawn such that it again be around the outer surface 306 of the wheel 302.

In the example shown, a guide 312 is provided to help direct the sample 304i aligned with the gap 314 between the rollers 310 between the gap 314. However, it will be appreciated that the guide 312 is optional and may be omitted.

The apparatus 300 also includes a controller (not shown). In a similar fashion to the examples described above, the controller includes an interface, memory and processor. Motors for rotating the wheel 302 and rollers 310 are also provided.

In a similar fashion to the above examples, a selection of a sample 3041 is received over the interface, and the controller causes the wheel 302 to rotate until the selected sample 304i is aligned with the gap 314 between the rollers 310. The controller then activates the rollers 310 so that the sample 304i can be displayed.

The controller can activate the rollers 310 to withdraw the sample 304i after a predetermined time after the selection et a different sample 304, or after some other suitable indication that the sample 3041 is no longer required.

The apparatus 300 shown in FIG. 9 may be provided in a housing (not shown). The housing may have an aperture aligned with the gap 314 between the rollers 310, such that only the selected sample 304i is outside the housing. The housing may be openable such that the wheel and/or samples can be interchanged.

In the above example, the samples have been arranged around a wheel 302. However, it will be appreciated that any suitable rotating element, such as a belt or cylinder, may also be used. It may also be that the wheel 302 (or other rotating element) and/or rollers 310 may be controllable manually instead of/as well as by the controller.

In all of the above examples, the selected sample 304i is aligned for display using stored sample positions from a memory, However, an alternative mechanism could be used in all the above examples. In the alternative mechanism, an identification code (for example barcode, QR code, identification number etc . . . ) is associated with each sample, and a reader is provided.

The reader is coupled to the processor and memory, so that it can read the identification code and the processor can determine the sample associated with it The codes and reader are arranged such that when an identification code is aligned with the reader, the associated sample is in a suitable position for display.

This can be achieved by, for example, having the code and sample in the same place, and having the reader positioned adjacent the display position. Alternatively, the code may be spaced from the associated sample by, for example 180 degrees, and the reader is also displaced from the display position by 180 degrees.

It will also be appreciated that, in the above examples, the controllers are set up to move from one selected sample to the next. In some examples, the option of incremental movement may be provide in addition or instead of this.

It will be understood that the sample holders 21, rollers 214, 216 and the wheel 302 with anchors 208 all bold or support the samples, and thus the holders 21, rollers 214, 216 and anchors 308 mounted on the wheel 302 can all be considered as examples of sample supports.

It will also be understood that the invention is not limited to the embodiments described herein and that features of the apparatus may be altered, omitted or adapted according to the requirements of the apparatus. It will also be understood that the invention includes any novel feature described herein as well as combinations and sub-combinations of any of the features and equivalents thereof.

1-42. (canceled)

43. An apparatus arranged to store and display a plurality of material samples, the apparatus comprising:
a plurality of sample supports arranged to hold the material samples, the sample supports being moveable to allow a user to access a selected material sample;
a housing having an aperture;
a controller configured to receive a selection identifying a material sample to be displayed; and
a display mechanism configured to move the selected sample from a first position within the housing, to an extended position in which at least a portion of the selected sample is projected through the aperture, such that it is visible and/or touchable by a user.

44. An apparatus as claimed in claim 43, further comprising:
a retention mechanism configured to prevent removal of the selected sample from the apparatus.

45. An apparatus as claimed in claim 43, wherein the display mechanism is configured to withdraw the selected sample from the extended position to the first position.

46. An apparatus as claimed in claim 43, wherein the samples are moveable with respect to the aperture, and wherein the display mechanism is configured to cause the samples to move in order to align the selected sample with the aperture in the housing, prior to moving the selected sample from the first position to the extended position.

47. An apparatus as claimed in claim 46, further comprising:
identification means associated with each sample; and
reading means to determine the identity of a sample aligned with the aperture.

48. An apparatus as claimed in claim 47, wherein the controller is arranged to:
cause the samples to move relative to the aperture;
based on the identification means, determine a sample aligned with the aperture;
if the sample aligned with the aperture does not correspond to the selected sample, repeat the steps of moving the sample and determining the sample aligned with the aperture.

49. An apparatus as claimed claim 43, wherein the apparatus further comprises a first housing holding a first plurality of samples and a second housing holding a second plurality of samples, wherein a first sample from the first plurality of samples can be displayed independently of a second sample from the second plurality of samples.

50. An apparatus as claimed in claim 43, further comprising:
a rotating element, arranged to rotate around a first axis, and wherein samples in the first position are arranged circumferentially around the surface of the rotating element.

51. An apparatus as claimed in claim 50, the display mechanism further comprising:
means for moving the selected sample perpendicular to the first axis.

52. An apparatus as claimed in claim 51, wherein the rotating element is arranged to rotate to align the selected sample with the aperture.

53. An apparatus as claimed in claim 50, wherein the rotating element has a thickness along the first axis, and wherein the sample supports are arranged to hold the samples within the first thickness.

54. An apparatus as claimed in claim 50, wherein each sample support is arranged to hold a sample along a first edge of the sample, parallel to the first axis.

55. An apparatus as claimed in claim 43, wherein each sample is held in the sample support at a first edge, and wherein the display mechanism is arranged to pull a free edge of the selected sample, opposite the first edge.

56. An apparatus as claimed in claim 55, wherein the display mechanism comprises a pair of counter-rotating rollers, arranged such that when the rollers are rotated, the selected sample is pulled into a gap between the rollers, and projected beyond the rollers, out of the aperture in the housing, wherein the gap between the rollers is aligned with the housing.

57. An apparatus as claimed in claim 56, wherein operating a first of the rollers in one direction, and a second of the rollers in the opposite direction moves the selected sample from the first position to the extended position, and reversing the direction of rotation of the rollers withdraws the selected sample.

58. An apparatus as claimed in claim 56, wherein the rollers are rotated by a motor.

59. An apparatus as claimed in claim 56, wherein the display mechanism includes a guide arranged to align the selected sample with the gap between the rollers.

60. A system comprising:
an apparatus as claimed in claim 43; and further comprising:
a computing device for internet shopping, the computing device in communication with the apparatus,
wherein the selection identifying a support is generated in response to a user selecting an item on an internet shopping web page.

61. A method of delivering a material sample to a user, the method comprising:
a) using a selection mechanism to select a material sample;
b) causing the selection mechanism to communicate the identity of the selected material sample to an apparatus arranged to store a plurality of material samples; and
c) causing the apparatus to show the user the selected material sample, by projecting the selected material sample through an aperture in a housing encasing the plurality of samples.

62. A machine readable medium containing instructions which when loaded onto a computer cause that computer to provide the data arranged to provide the computing device of claim 61.
